(19) United States
(12) Patent Application Publication
(10) Pub. No.: US 2021/0374659 A1
(43) Pub. Date: Dec. 2, 2021

(54) Real Time Event Tracking and Digitization for Warehouse Inventory Management

(71) Applicant: Vimaan Robotics, Inc., Santa Clara, CA (US)

(72) Inventors: Srinivasan K. Ganapathi, Palo Alto, CA (US); Shubham Chechani, Bhilwara (IN); Michael A. Stearns, Milpitas, CA (US); Dheepak Khatri, Milpitas, CA (US)

(21) Appl. No.: 17/331,853

(22) Filed: May 27, 2021

Related U.S. Application Data
(60) Provisional application No. 63/030,543, filed on May 27, 2020.

(51) Int. Cl. G06Q 10/08; B65G 69/28; B65G 1/137; B66F 9/075

(52) U.S. Cl. CPC G06Q 10/087; B65G 69/2882; B65G 2209/04; B65G 1/1373; B66F 9/0755; B65G 1/1371

(57) ABSTRACT

Tracking and digitization method and system for warehouse inventory management is provided to greatly increase the visibility of the events at a warehouse, provide a comprehensive cataloging of every single event, compare that event against the expected event, and report any discrepancies immediately so that they can be fixed prior to causing costly mistakes. Further, it reduces the need for costly quality control personnel in the warehouse. Embodiments of this invention greatly enhance the accuracy of inventory, at a vastly reduced cost. In an indoor environment, GPS cannot be used to track the location of the forklifts or vehicles in the warehouse because most warehouses have metal constructions and present a “GPS denied” environment. Hence one must resort to vision, lidar, or inertial, or a combination of such sensors to accurately track location.

### CROSS-REFERENCE TO RELATED APPLICATIONS

This application claims priority from U.S. Provisional Patent Application 63/030543 filed May 27, 2020, which is incorporated herein by reference.

### FIELD OF THE INVENTION

This invention relates to warehouse inventory management devices, systems and methods.

### BACKGROUND OF THE INVENTION

Regions or activities in a warehouse can generally be classified into a few zones. These are classified and described in the order in which inventory typically flows through the warehouse.

A first zone is the incoming/receiving zone. A typical warehouse has a receiving area that includes several receiving docks for trucks to pull up and unload their pallets. These pallets are usually scanned, entered into the system, inspected and validated against the accompanying paperwork, and then moved (in whole or after splitting them up into cases, boxes or cartons) to their storage locations within the warehouse. All the steps in this process are currently conducted manually and are thus rather labor intensive. Further, once the incoming pallets or boxes are put away in their respective locations on the racks and shelving, quality control personnel are usually dispatched to verify that the items were indeed put away in the appropriate locations.

A second zone of the warehouse is the storage, also referred to as reserve or racking area. In this section of a warehouse, the pallets containing cases or boxes that are placed on the shelves are stored until they need to be picked and shipped out of the warehouse. Another frequently occurring model is that these cases or boxes are opened up and sub-units are picked from these cases to fulfill smaller orders, which are then separately packaged and shipped out of the warehouse. In this reserve section, the activities that occur are therefore predominantly the put away of the pallets to specific locations on the racks, or the picking of items from these pallets or cases, which leaves the inventory locations with partial inventory. A typical warehouse also maintains several quality control personnel whose daily job is to monitor whether the right cases are in the right locations and also whether there is the right count of inventory in the partially opened pallets or cases.

A third zone of a warehouse is a packing area. Here, the picked items from the storage area are consolidated and packed into boxes that are meant to be shipped to customers. Once again, quality control personnel are assigned to make sure that each box contains the right order and that the contents of each box correctly reflect the shipping label or bill of lading that would accompany the box.

A final zone of a warehouse is the shipping area. In this section, the individual packing boxes that are intended for a common destination (such as a retail store, or a hospital or another business or even a consumer's home) are consolidated on to a pallet or packing box and shrink wrapped. In some cases, the packing boxes are shipped directly to a destination location. The appropriate shipping labels are applied to the outside of the pallet or box and the entire pallet or box is loaded on to the truck through a shipping dock door. In this area too, quality control personnel are delegated to inspect and verify that the pallets or boxes have the full complement of constituent boxes, that they have the correct labels; that they are not damaged from handling; that there are customs papers if needed; and that they are loaded on to the truck properly. Until the moment the pallet is loaded on to the truck, the warehouse owns the inventory and has liability for it.

Accordingly, given such a flow in a warehouse, if one contemplates a warehouse with 40,000-70,000 pallets or boxes and a corresponding number of positions on racks and shelves, it can become very expensive to have quality control personnel track and verify the daily activity and the various events that occur in a warehouse. Warehouses sometimes see activity that exceeds 2000-3000 pallets or boxes coming in and leaving each day, and to control costs, only a small fraction of the inventory activity is verified (or audited) by the quality control personnel.

A misplaced box or pallet can prove to be very expensive, since when the time comes to pick the box or from it, if it cannot easily be found in the location that it is supposed to be in, it can cost hours of expensive searching and manual labor. Further, this could result in shipment delays which in turn could incur penalties from the customer or the manufacturer/shipper.

Similarly, if the wrong boxes are packaged up for shipment, or the wrong shipment labels are applied or the wrong quantities are picked, this results in shipment errors, which in turn result in reverse logistics related costs as well as loss of customer goodwill.

Further, even if the boxes and pallets are in appropriate locations in the storage areas of the racks in the warehouse, certain types of inventory require that they be stored within specific temperature and humidity ranges. In warehouses where the racks can reach up to 30 feet high, it is difficult to monitor and maintain compliance with these requirements without incurring excessive costs of frequently having a human make these measurements by driving forklifts through each of the aisles.

Accordingly, there is a need in the art for technology that addresses at least some of these problems.

### SUMMARY OF THE INVENTION

The present invention provides in one embodiment a method of tracking and digitization for warehouse inventory management. A warehouse with inventory locations stores inventory. The warehouse has unique markers throughout the warehouse for tracking location. Examples of the unique markers are warehouse markers on a wall, on a floor, on a bin, on a rack, placed overhead over the inventory locations, identifying an aisle, on light fixtures, or on pillars. These markers may be naturally occurring features that are already part of the warehouse, or specially placed in the warehouse to aid location information, or a combination thereof. The inventory has unique inventory information features for identifying inventory. Examples of the unique inventory information features are manufacturer logos, Stock Keeping Unit (SKU) numbers, Barcodes, Identification Numbers, Part numbers, box colors, or pallet colors.

A vehicle (such as a forklift truck, a pallet jack, an order picker, or a cart) capable of transporting the inventory and sometimes operated by a human operator (i.e. not an automatic vehicle or robot) moves throughout the warehouse and manipulates the inventory (referred to as the manipulation) or supports the manipulation of the inventory by the human operator. A plurality of cameras is mounted on the vehicle. The plurality of cameras are selected from the group consisting of one or more forward-facing cameras with respect to the vehicle, one or more top-down-facing cameras with respect to the vehicle, one or more diagonal-downward-facing cameras with respect to the vehicle, one or more upward facing cameras, one or more back facing cameras, one or more side facing cameras with respect to the vehicle.

The manipulation is defined as one or more of the steps of moving the inventory with the vehicle or by the operator from an entry of the inventory into the warehouse, storing the inventory by the at least one vehicle at the inventory locations, picking up the inventory with the at least one vehicle from the inventory locations, to a departure of the inventory out of the warehouse.

During the movement of the vehicle, images are captured of the unique markers in the warehouse by at least one of the plurality of cameras mounted on the vehicle. Vehicle location information of the vehicle is determined while the vehicle is moving throughout the warehouse by processing the captured images of the unique markers captured by at least one of the plurality of cameras mounted on the vehicle. The process for determining vehicle location information of the vehicle does not have or involve RFID tags or bar codes and furthermore the process for determining vehicle location information of the vehicle does not use RFID sensors for reading the RFID tags or bar code readers for reading the bar codes. In one embodiment, the process for determining vehicle location information of the vehicle only starts when the vehicle is moving.

Images of the inventory are captured with at least one of the plurality of cameras on the vehicle during the manipulation of the inventory. At least one of the captured images are digitized and unique inventory information features are extracted from the captured images of the inventory during the manipulation. The unique inventory information features uniquely identify the inventory. In one embodiment, the capturing of images of the inventory only starts when the human operator is about to manipulate the inventory.

A unique inventory location of the inventory is determined at the moment of the manipulation by synchronizing the extracted unique inventory information features and the determined vehicle location information of the vehicle. In one embodiment, the vehicle is further outfitted with position and inertial sensors to capture position and movement information of the vehicle and the inventory. The position and movement information could then assist in the determining of the unique inventory location of the inventory. A warehouse inventory management system is maintained with the determined inventory location during the manipulation.

In one aspect, more than one vehicle could be used in the method, each of which is responsible for specific aspects of the manipulation tasks/steps, or each of which are working in parallel with each other and responsible for all aspects of the manipulation tasks/steps.

In one aspect, the method relies essentially on (e.g. consisting essentially of) using cameras for the determining a unique inventory location of the inventory.

Aspects of the method require computer hardware systems and software algorithms to execute the method steps on these computer hardware systems. Aspects of the method require computer vision algorithms, neural computing engines and/or neural network analysis methods to process the acquired images and/or sensor data. Aspects of the method require database systems stored on computer systems or in the Cloud to maintain and make accessible the inventory information to users of the warehouse inventory management system.

In a further embodiment, the present invention is an apparatus, system or method to use a combination of human-operated vehicles, drones, sensors and cameras placed at various locations in a warehouse to track every event that occurs in the warehouse in a real-time, comprehensive and autonomous manner. By capturing every such event, a warehouse manager is then able to generate a ‘source of truth’ of the exact state of the warehouse at any given instant—including locations of items, the state of the items, damage, changes in temperature, events such as picks and puts of the inventory, etc.

In still another embodiment, the invention describes an apparatus to mount a series of cameras, sensors, embedded electronics and other image processing capabilities to enable a real-time tracking of any changes in the inventory in the warehouse, and to maintain accurate records of such inventory.

In still another embodiment, the invention includes updating the inventory in the warehouse management system when the inventory is picked from the unique inventory location or put away to the unique inventory location.

In still another embodiment, the invention includes verifying that a correct number of inventory items has been picked from the unique inventory location or put away to the unique inventory location.

In still another embodiment, the invention includes building a digital map of the unique inventory locations of the inventory in the warehouse.

In still another embodiment, the invention includes using software to obscure faces to maintain privacy.

In still another embodiment, the invention includes using face recognition software to recognize faces for security in the warehouse.

In still another embodiment, the invention includes using face recognition software to ensure that only certified vehicle operators are operating the vehicles.

In still another embodiment, the invention includes utilizing vehicle location information throughout a day or time window to improve productivity and efficiency. In one example the method includes tracking labor and equipment productivity. Based on the tags that are mounted on the various shelves in the warehouse and the sensors and cameras that are mounted on the vehicles, one can track the location of each vehicle (e.g. forklift) at any given time.

In still another embodiment, the invention includes handling Multi-Deep Shelving. In many instances, the boxes in the warehouses are not large enough to occupy the entire depth of a rack, which could be as much as 5 feet. Therewith, the warehouses stack boxes in a multi-deep manner: the boxes are stacked one in front of the other.

Embodiments of the invention have the capability to greatly increase the visibility of the events at a warehouse, provide a comprehensive cataloging of every single event, compare that event against the expected event, and report any discrepancies immediately so that they can be fixed prior to causing costly mistakes. Further, it reduces the need for costly quality control personnel in the warehouse. Simply put, embodiments of this invention greatly enhance the accuracy of inventory, at a vastly reduced cost.

In an indoor environment, GPS cannot be used to track the location of the forklifts or vehicles in the warehouse because most warehouses have metal constructions and present a “GPS denied” environment. Hence one must resort to vision, lidar, or inertial, or a combination of such sensors to accurately track location.

Embodiments of this invention are more effective than placing fixed cameras or sensors in the warehouse. Fixed cameras need to be placed at very close proximities to each other to detect the movement of forklifts to any degree of precision. Given the large sizes of warehouses, such fixed cameras make the solution excessively expensive and commercially non-viable. Further, fixed cameras require power and other infrastructure routing to many thousands of locations in the warehouses, including ceilings, racks, and pillars, which makes the solution even more expensive to maintain. A large number of cameras also significantly increases the data transmission and data processing bandwidth requirements, which further decreases the attractiveness of this solution.

### BRIEF DESCRIPTION OF THE DRAWINGS

FIG. 1 shows according to an exemplary embodiment of the invention event tracking at each stage of inventory movement through the warehouse and the overall scope of the invention for inventory management in a warehouse.

FIG. 2 shows according to an exemplary embodiment of the invention a camera-based inventory management method and system.

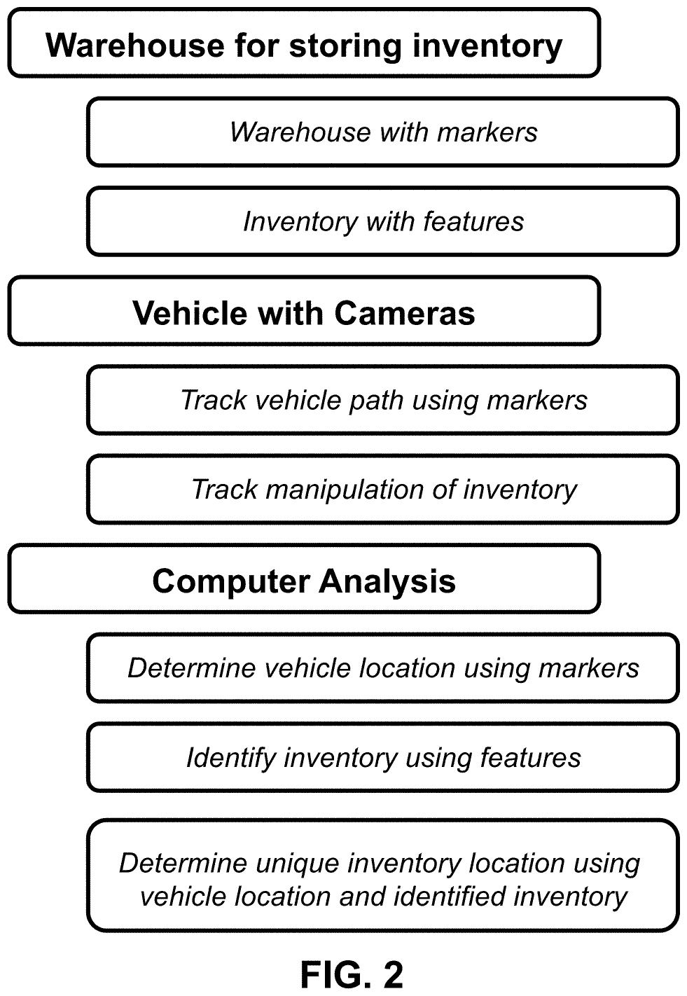

FIG. 3 shows according to an exemplary embodiment of the invention a demonstration of QC Gate setup. A forklift is driven through 3-beam gate and multiple cameras and sensors mounted on the beams capture the data while the vehicle is crossing it.

FIG. 4 shows according to an exemplary embodiment of the invention a visualization of frames captured at different time instances from cameras of the same beam. Some overlap across images of cameras can be observed.

FIG. 5 shows according to an exemplary embodiment of the invention a workflow of the overall pipeline from data capture to output dump for the QC Gate.

FIG. 6 shows according to an exemplary embodiment of the invention a diagrammatic explanation of relevant frame identification mechanism. Ticks represent frames in which box masks were identified. Crosses represent the frames with no box object masks. Since networks are bound to have few false negatives, taking a statistical mode across cameras mitigates that limitation.

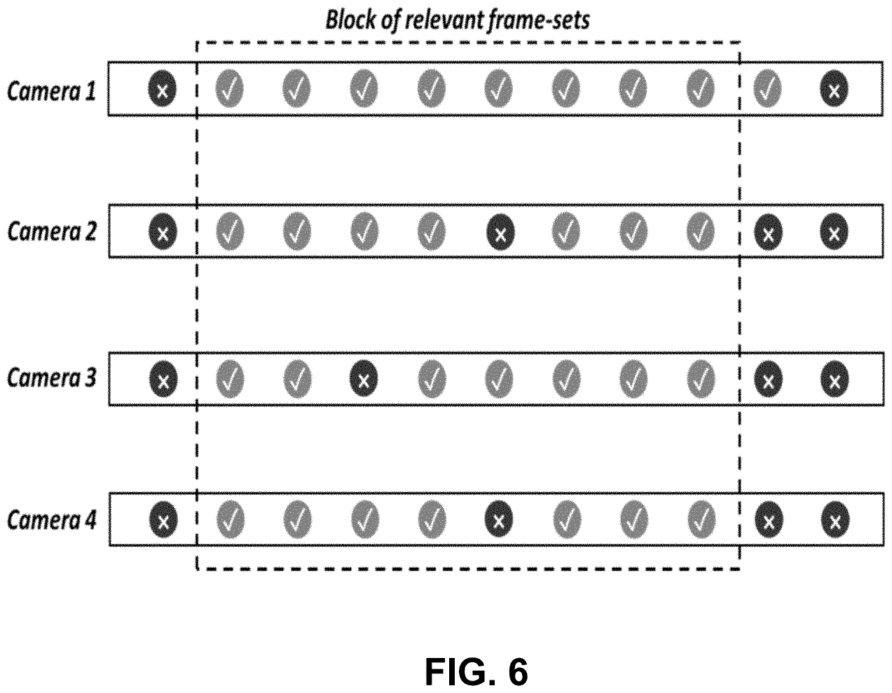

FIG. 7 shows according to an exemplary embodiment of the invention a representation of a stitching framework. First intra-camera stitching is performed on frames from the same camera. Then inter-camera stitching is performed on pre-stitched images.

FIG. 8 shows according to an exemplary embodiment of the invention inter-camera stitching of color and object masks. ‘Blue’ masks represent boxes, ‘yellow’ masks are for text labels and red identify damage on the boxes. Color has been converted in gray scale.

FIG. 9 shows according to an exemplary embodiment of the invention a setup of a warehouse vehicle with multiple cameras mounted on a cherry picker. Three cameras mounted on the cherry picker are top-down from roof (in ‘red’ 910), towards the rack (in ‘blue’ 920), looking diagonally down from the roof towards rack and operator (in ‘green’ 930). Color has been converted in gray scale.

FIG. 10 shows according to an exemplary embodiment of the invention a timeline of an entire transaction as it is currently conducted by operators in the warehouse, and involves sequential actions such as bar-code scanning, unboxing, multiple picking or placing and boxing. The present invention does not use barcode scanning.

FIG. 11 shows according to an exemplary embodiment of the invention example frames of key actions: unboxing and picking.

FIG. 12 shows according to an exemplary embodiment of the invention a workflow of the overall pipeline from data capture to output dump for the PickTrack.

FIG. 13 shows according to an exemplary embodiment of the invention a diagrammatic explanation of action segmentation mechanism. Each frame has an action associated with it. Crosses represent that no action could be identified with reasonable confidence. Since networks are bound to have few false detections, taking a statistical mode across cameras mitigates that limitation.

FIG. 14 shows according to an exemplary embodiment of the invention segmentation and tracking results shown on a video segment. Object correspondence across frame is shown through color as well as ID. Only the picked items are highlighted to make the visualization better.

FIG. 15 shows according to an exemplary embodiment of the invention before and after snapshots of an opened box. Instance segmentation network is applied on both images to identify missing or extra items. In the example, one can find that 3 items are missing in the “after” image. Only the delta items are highlighted to make the visualization better.

FIG. 16 shows according to an exemplary embodiment of the invention a setup on the QC Station platform where packed items are being verified.

FIG. 17 shows according to another exemplary embodiment of the invention a setup on the QC Station platform.

FIG. 18 shows according to an exemplary embodiment of the invention a workflow of the overall pipeline from data capture to output dump for the QC Station.

FIG. 19 shows according to an exemplary embodiment of the invention the label detection and text reading for the QC Station.

FIG. 20 shows according to an exemplary embodiment of the invention the stitching of images using pair wise images and feature mapping and pairing.

FIG. 21 shows according to an exemplary embodiment of the invention the consolidation of multiple images with the same features.

FIG. 22 shows according to an exemplary embodiment of the invention the generation of a discrepancy list based on information present in the Warehouse Management System.

### DETAILED DESCRIPTION

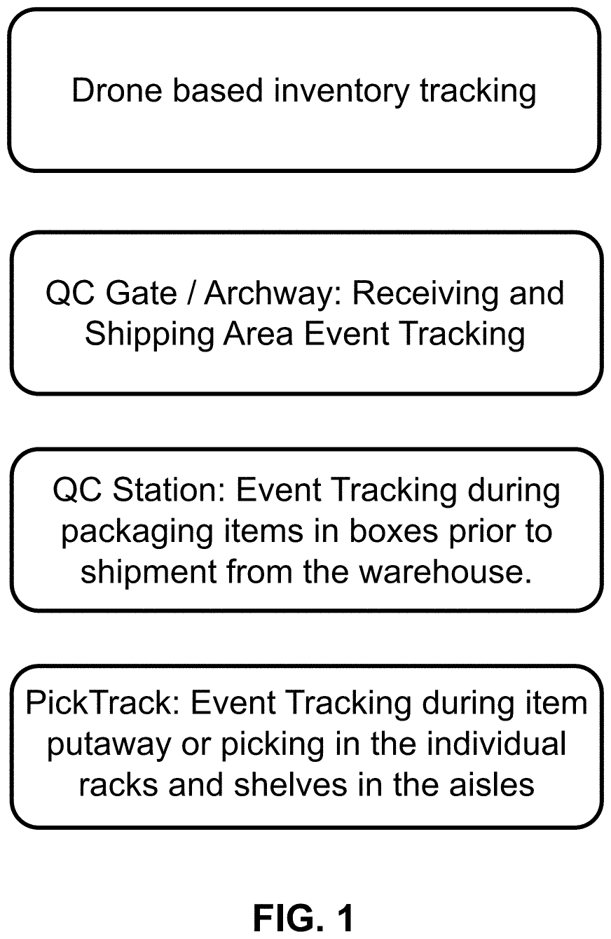

In a general overall scope or pipeline of the invention for inventory management in a warehouse, FIG. 1 shows an example of the various locations where inventory and activities/events are tracked within the warehouse and the methods by which this invention enables this tracking. One such method in the overall scope involves Drone-based Inventory Tracking (See PCT/US2020/049364 published under WO2021/046323).

### Drone Based Inventory Tracking

A drone scans the aisles and captures information from pallets and boxes that are stored on the racks (FIG. 1). The drone operates autonomously and captures data at frequent and regular intervals. The drone is docked indoors on a base station. At pre-defined intervals, the drone takes off autonomously, and then autonomously follows a prescribed path along a warehouse aisle and captures a variety of information from the inventory stocked on the shelves (including occupancy, damage, spacings, or any other irregularities). It then autonomously lands on the base station and automatically recharges the battery and simultaneously uploads the captured videos, images and other sensor information to the computers which use Computer Vision (CV) image processing software to generate warehouse specific data that seamlessly integrates into the customer's Warehouse Management System (WMS) software database for real-time visibility.

Further to the overall scope are capabilities such as (FIG. 1):
QC Gate/Archway: Receiving and Shipping Area Event Tracking, and
QC Station: Event Tracking during packaging items in boxes prior to shipment from the warehouse, and
PickTrack: Event Tracking during item putaway or picking in the individual racks and shelves in the aisles.

### QC Gate: Receiving and Shipping Area Event Tracking

In the receiving and shipping locations of the warehouse, embodiments of the invention describe an archway near the receiving and shipping dock doors of the warehouse. This archway (also known as the QC Gate) has vertical and horizontal beams on which are mounted a series of cameras and sensors. Whenever these sensors sense that a forklift truck is entering or leaving the warehouse with pallets, they immediately turn on the cameras and sensors which capture the information from the incoming or outgoing pallets. This information is processed by the Computer Vision and Image Processing software to stitch together all the information and extract information such as shipment labels, box dimensions, damage to the boxes, or any other information deemed critical by the warehouse manager. This information is then compared against the Warehouse Management System (WMS) to determine if there are any discrepancies between the incoming or outgoing bills of lading and the actual shipment. More details on the method of image processing of the QC Gate is provided in the PIPELINE section infra.

### QC Station: Event Tracking During Packaging Items in Boxes Prior to Shipment From the Warehouse

Another area in the warehouse that needs to be tracked is the packing area. In a typical warehouse, the picked items are packaged into boxes that are then consolidated into larger pallets or boxes for shipment. However, the warehouse needs to conduct Quality Control checks on each box to ensure that the box contains the appropriate items, the correct numbers of each item, the correct SKU, no damage to the item, etc. This QC Station according to an embodiment of this invention involves the steps of:
reading of the same “pick list” from the WMS database, which also contains information on how many and which items each such box should contain;
using a combination of cameras and sensors to capture this information and read the labels, capture the item dimensions, look for damage, and also create a photographic archive of the contents of the box in case of future dispute resolution; and
in case there is a shipping label or a packing list that accompanies each box, the QC Station can also scan the document, use computer vision software to extract the relevant quantities of each item that are supposed to be in the box and match that against the physical contents of the box to ensure that they match.

The entire QC Station is especially valuable and relevant in many reverse logistics warehouses, where the warehouse is responsible for repairing and sending back items to individual locations. An example could be a phone repair or a laptop repair facility: the warehouse operator is required to re-furbish and pack thousands or millions of shipments with the appropriate phone, the charging unit, the earpiece set, the manual, etc. To ensure that each shipment indeed contains the required items the QC Station can be deployed.

Now a key component to the embodiments in this invention and contributing to the overall scope for inventory management in a warehouse is the PickTrack, which is Event Tracking during item picking in the warehouse. In one embodiment this is the individual racks and shelves in the aisles (FIG. 1).

### PickTrack: Event Tracking During Item Picking in the Individual Racks and Shelves in the Aisles

This invention also includes attaching special cameras and sensors to vehicles (e.g. forklifts which is used as an example but the invention is not limited to forklifts) and picking equipment/inventory in the warehouse. These cameras and sensors are positioned strategically around the forklift so that they can capture the location of the forklift at any given instant and also the motion of the warehouse worker who is performing the picking action. This embodiment works in the following manner:
The warehouse worker who is driving the forklift typically starts with a pick list. This is a list of items he has to pick from the individual rack locations in the warehouse, or from within a given box at a given location. The pick list also specifies how many of the individual items the worker should pick from a given location. The worker typically goes to the first location, picks the required number of items from a box in a given location (defined by the position within a shelf on a specified rack) and places those items either in a tote or on a temporary table that is also on the forklift. Once he is done picking from this location, he drives the forklift to the next location, picks the necessary quantity of items from that location, and then adds them to the tote or the table on the forklift.
The sensors and the cameras contemplated by this embodiment are placed at various positions on the forklift. The embedded electronics connected to the sensors and cameras also receive the same picklist as the worker receives when he begins picking the various items. As the warehouse worker drives the forklift to the location, the sensors track the location of the forklift, and when the worker arrives at the first pick location, the sensors detect that he has arrived at the location, and the cameras now start recording the motion of the worker and the items that he is picking. The image processing algorithms automatically verify that he is picking from the right location, picking the right item from the correct box, and also that he is picking the correct quantity of items from the box. The image processing software automatically verifies that the correct quantity of the correct item from the correct box has been picked. this serves as an automatic Quality Control check on the pick event. Details on the image processing required to conduct this quality control check of the pick event are described in the PIPELINE section infra.

This same scheme of using the cameras on the forklifts can also be used for multiple other event tracking functions within the warehouse operations. Several such applications and use cases are listed below:
PutAway Verification: If the warehouse worker is expected to put away an incoming pallet or box at a specific location (marked by an address on the rack shelving), then this PickTrack approach can be used to verify that the pallet has indeed been put away at that location, rather than at a different, erroneous location. In this way, PickTrack serves as an automatic, instantaneous Quality Control check of the correct location.
Each Item Counting: Often, multiple Quality Control personnel are assigned to verify the inventory within partially picked pallets or boxes. If an incoming pallet has 100 items and multiple workers are assigned to pick different item counts from that box at different points in time to fulfill different orders, then it is very important to maintain a physical verification of the remaining number of items in that pallet to avoid costly delays when a picker is sent to pick more units from that box. In theory, the Warehouse Management System database is supposed to keep track of the number of remaining items within a box, but due to errors in picking, there could be an incorrect count of items in the box. Further, auditing companies require that a full physical count of each item and box in the facility be conducted on a quarterly or semi-annual basis for the entire warehouse; a costly and time-consuming process.
PickTrack enables the elimination of such physical counts and item verifications. By keeping track of precisely where a picker has picked from, and the number of items he has picked, the system can automatically deduct the number of items from any given box or pallet at any given location. That allows the PickTrack to ensure that any picking errors are immediately highlighted and corrected, which in turn ensures that without conducting a frequent physical human count, the system allows a real time, detailed tracking of the number of items remaining in each box or pallet. In other words, it serves as a Source of Truth for the WMS database. It allows elimination of the labor for daily physical audits as well as the quarterly audits. More importantly, it provides archival evidence of every single pick, which in turn can be used to go back and review photographic archival data on how many items were picked from a given location over a period of time.
Multi-Deep Shelving: In many instances, the boxes in the warehouses are not large enough to occupy the entire depth of a rack, which could be as much as 5 ft. Therewith, the warehouses stack boxes in a multi-deep manner: the boxes are stacked one in front of the other. As can be imagined, the counting and quality control in such instances becomes more expensive because the worker has to reach behind the boxes to count what is not easily visible behind the frontline boxes. PickTrack helps tremendously in such cases: Because it is tracking where each box is being put away immediately after being received into the warehouse, it can also understand how deep it is within the rack. The PickTrack system allows a digital buildup of the inventory in the warehouse: Each time a box is added to a location, its size and shape and its exact location (including depth) on the shelf are registered and used to build up a true Digital Twin of the items in the warehouse. Subsequently, as long as that item is not picked from, the system can record its presence and contents.
Cold Storage: Many warehouses deal with food and beverage items as well as pharmaceuticals or other biotech devices that need to be stored and maintained in a cold storage facility or special reserve/storage area. Frequent quality control in these situations is very expensive, since it is difficult for workers to survive in such conditions for long periods. For such situation, PickTrack is a perfect solution and allows real-time tracking and verification of any putaways, picks or other events that may occur.
Floor level Stacking and Storage: In many warehouses, the items are either too big, or there is not enough room on the racking and shelves, and items are placed in an orderly manner on the floor. It is difficult for quality control personnel to sometimes open and count inside such boxes if they have been partially picked. PickTrack again eliminates this need and allows tracking of exactly how many items have been picked from each box and therefore deduce how many are remaining in each box.

There are also other aspects of the embodiments that become important in the context of deploying it across the entire warehouse in the manner described above.
One additional embodiment which can be included is the blurring out of human faces and hands to maintain privacy.
Conversely, if needed, the software and cameras can be configured to recognize human faces if needed for security. This can ensure that the wrong personnel are kept out of the facility or out of restricted areas of the warehouse.
Allow to track labor and equipment productivity: Based on the tags that are mounted on the various shelves in the warehouse and the sensors and cameras that are mounted on the vehicles, one can track the location of each vehicle (e.g. forklift) at any given time. This in turn allows the warehouse manager to better understand the utilization of the vehicles, the paths they are taking to get to a specific location, and also the time spent at each location—thus providing critical insights into the productivity of both the worker that is operating the vehicle as well as the utilization of the vehicle equipment in the warehouse.
In almost all the use cases described above (QC Gate, PickTrack (see infra) and QC Station), the sensor/camera module is turned on only when needed to conserve power as well as to not create an uncomfortable working experience for the warehouse operators. This can be done through a variety of means—such as automatically detecting the location of the forklift and turning on at the right moment; detecting that the forklift has stopped and turning on at that time; detecting when a box is in front of the QC Station or QC Gate sensor module and turning on at that time, etc.

### Pipeline

### QC Gate Pipeline

### Objective

Scan and inspect the outbound or inbound shipment pallet for the following:
Number of boxes
Dimensions of boxes
Label on the boxes
Damage detection

### Setup

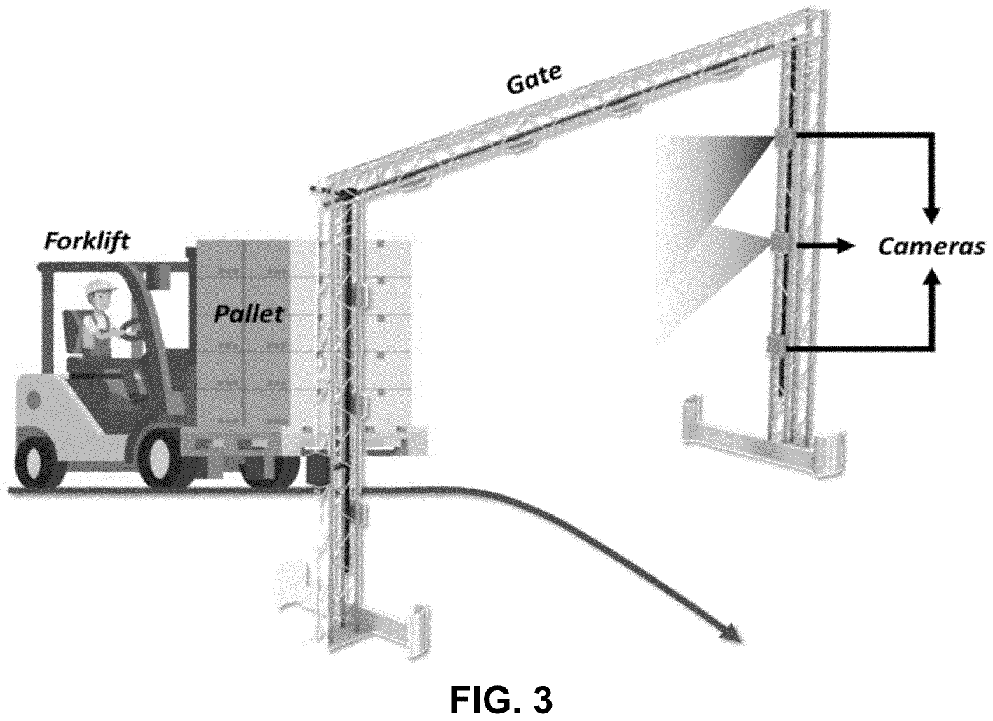

The setup on the platform is demonstrated in a pictorial way in FIG. 3 which shows a demonstration of QC-Gate setup. The forklift is driven through a 3-beam gate and multiple cameras and sensors mounted on the beams capture the data while the vehicle is crossing it.

### Capture Mechanism

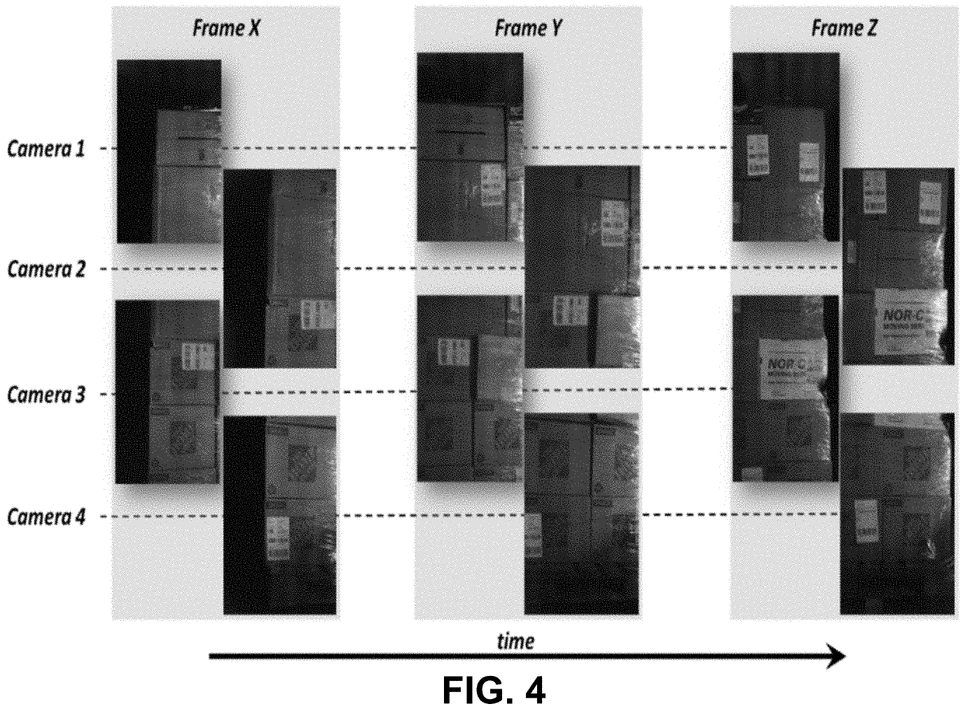

Each beam of the gate has multiple cameras mounted on them which record the pallet as it moves through the gate (FIG. 4). The cameras have overlapping field of view (FoV) with neighboring cameras to get correspondence of objects across cameras. The capture is triggered using a visual/distance-based sensor which is looking towards the path for any incoming forklift. Once an incoming forklift is identified, a capture is triggered across cameras to record the passing of the forklift through the gate. Distance sensors are placed along each camera to measure the orthogonal distance of a pallet from the camera.

### Workflow

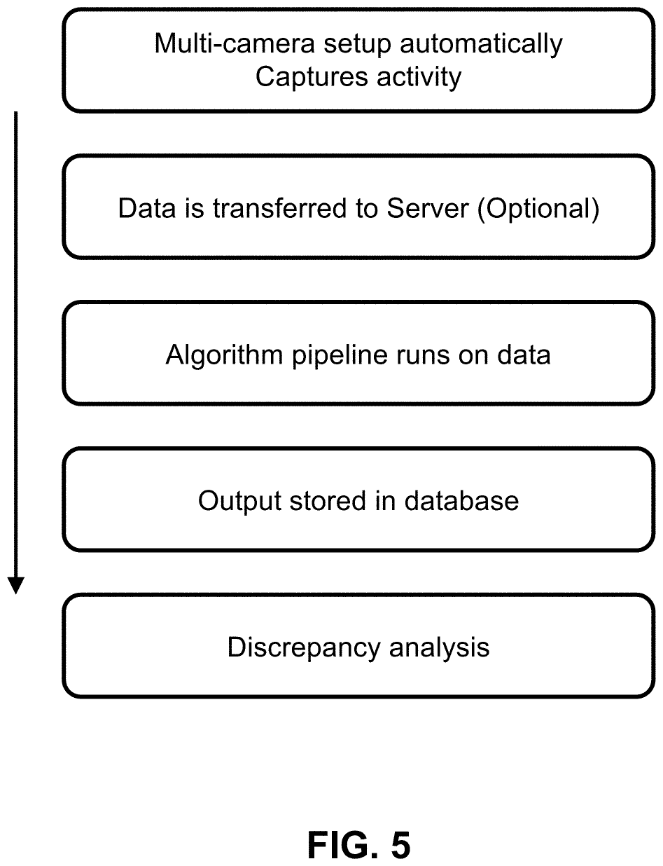

The workflow of this pipeline is shown in FIG. 5 from data capture to output dump.

### Algorithm

### Summary

Inference
   Box, text and damage segmentation
   Text recognition
   Association of text and boxes
Identification of relevant frames
Stitching
   Intra-camera
   Inter camera
Consolidation
Discrepancy analysis

### Inference

A machine learning network is applied to detect and get masks around boxes, text and damage. The masks of text-regions are then used to crop the original image and is given as an input to the text recognizer network. Since the orientation of the text is not known, the cropped images are flipped vertically also to cover cases where boxes are placed upside down. Even partial boxes and text regions are detected. Once, text is recognized, boxes and text are associated by checking overlap using a metric called intersection over union (IoU).

### Identification of Relevant Frames

When the incoming forklift is identified, camera recording starts a few seconds before the actual crossing of the forklift. Similarly, recording is stopped a few seconds later after the crossing of the forklift past the gate. This results in recording of few extra frames with no relevant data and should be excluded for further analysis. In order to do this, the existence of box in each frame is identified through previously detected output masks. Then for each frame-set across cameras, statistical mode is applied to identify if the particular frame-set is relevant. The largest contiguous block of relevant frame-set is chosen for further processing. FIG. 4 shows a diagrammatic explanation of relevant frame identification mechanism. Ticks represent frames in which box masks were identified. Crosses represent the frames with no box object masks. Since networks are bound to have few false negatives, taking a statistical mode across cameras helps mitigate that limitation.

### Stitching

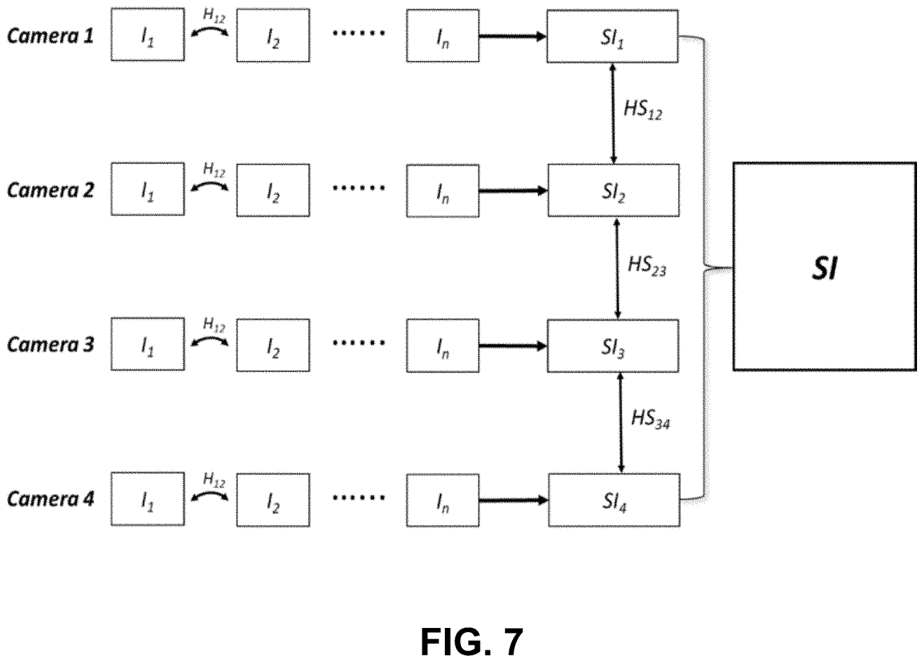

Stitching is performed in two ways; intra camera and inter camera. The frames from each camera are used to perform intra-camera stitching. To perform stitching, pair-wise images are taken and features extracted. After feature extraction, the features are matched to get correspondences. Feature matching is evaluated through metrics to filter out weak matches. Strong matches are then carried forward to compute homography matrix transformation between the images. The same transformation derived from images is then applied to box and text coordinates as well. FIG. 7 shows a representation of stitching framework. Firstly, intra-camera stitching is performed on frames from the same camera. Then inter-camera stitching is performed on pre-stitched images.

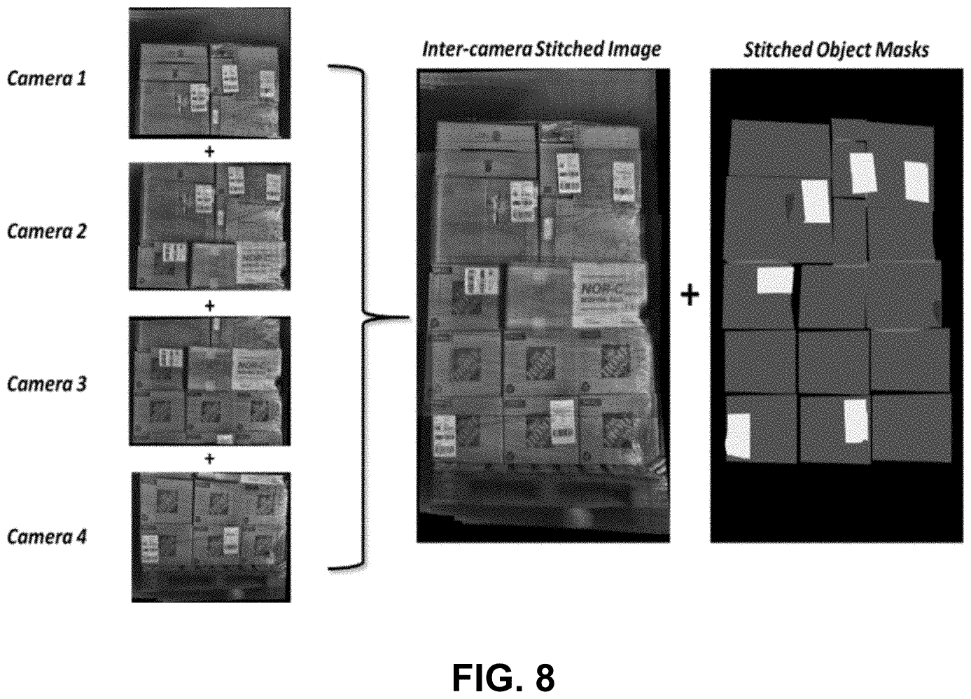

Inter-camera stitching is performed using the stitched images from each camera as input. Known positional information of cameras is used to get overlap direction to give a more accurate mask for feature detection. For example, when images from Camera1 and Camera2 are stitched, features are extracted from bottom-half of Camera1 and top half of Camera2. This helps to avoid getting features from non-overlapping regions. This task is performed for all intra-camera stitched images to get full stitched image of the pallet. The homography matrices computed for color images are also then used to compute stitched images for object masks (see FIG. 8). Individual masks having overlap in stitched images are merged together using a threshold value of IoU. FIG. 8 shows inter-camera stitching of color and object masks. Blue masks represent boxes, yellow masks are for text labels and red identify damage on the boxes.

### Consolidation

The stitched object masks images are used to analyze the boxes for dimensions, damage, text and units. All the individual object masks are brought to same stitched canvas. The same homography transformations are also applied to the object masks. Some boxes are captured partially in each frame. Transformed boxes are merged based on overlap metric IoU. After merging all the masks, consolidated output is evaluated to find boxes and their corresponding text and damage extent. This process of stitching and consolidation is performed on all data from all 3 sides of the gate. Since distance sensors are also placed with each camera, there is enough information to form a 3D model of the pallet using the output from all 3 cameras. Using distance values from sensors, the physical spacing mapping is obtained between pixels on stitched image and thereby helping us to get physical dimensions of the objects.

### Discrepancy Analysis

The algorithm output is compared with data from warehouse database. The aim is to identify any discrepancy and report to the operator. The discrepancies covered under the analysis will be to identify number of boxes, incorrect size and incorrect tags and damaged items. Once discrepancies are identified, one can notify the operator with links to original image for manual verification.

### Customer Analytics Use Cases

Identify discrepancies:
   Number of boxes
   Boxes with incorrect tag
   Boxes with damage
   Dimension of individual boxes
   Dimension of overall pallet
Forklift movement profiling
   Driving pattern analysis

### Picktrack Pipeline

### Objective

Count and verify the items picked from or placed into a box or inventory location through visual imagery of the activity performed. The scene is captured from multiple cameras to cover the activity from different perspectives. The aim is to identify and subsequently verify the number of items involved in the transaction to generate any potential discrepancies.

### Setup

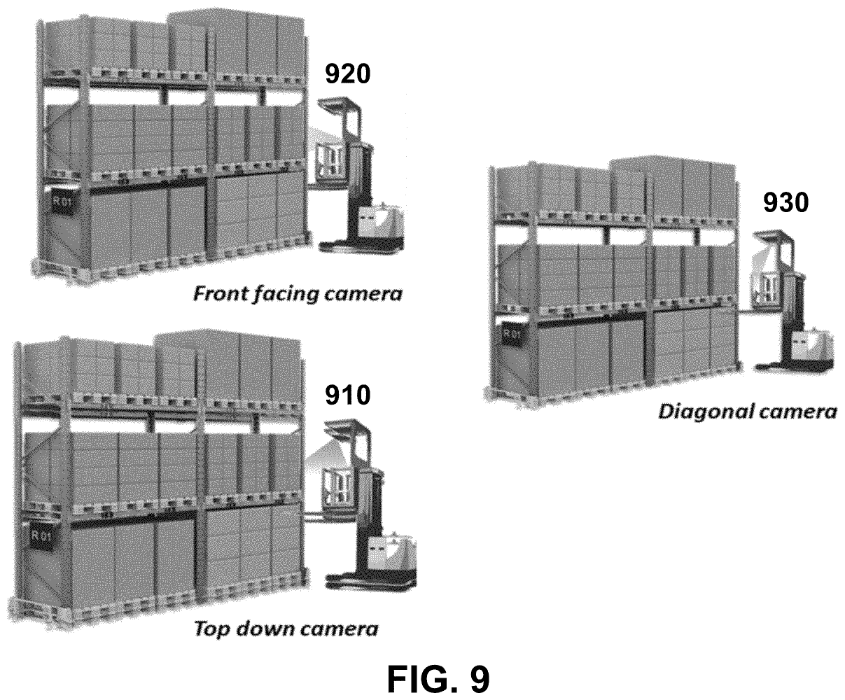

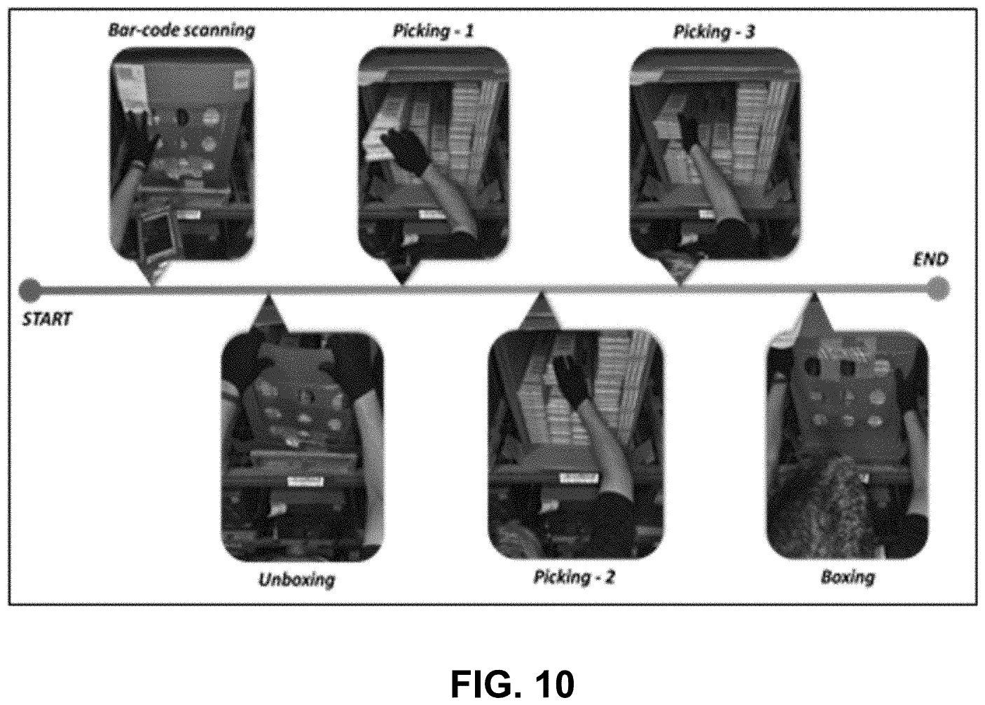

The setup on the platform is shown in FIG. 9 which shows a setup of a PickTrack with multiple cameras mounted on the cherry picker. Three cameras mounted on the cherry picker are top-down from roof (in red 910), towards the rack (in blue 920), looking diagonally down from the roof towards rack and operator (in green 930). FIG. 10 shows a timeline of the entire transaction as it is currently conducted by operators in warehouses and involves sequential actions such as bar-code scanning, unboxing, multiple picking or placing and boxing.

### Capture Mechanism

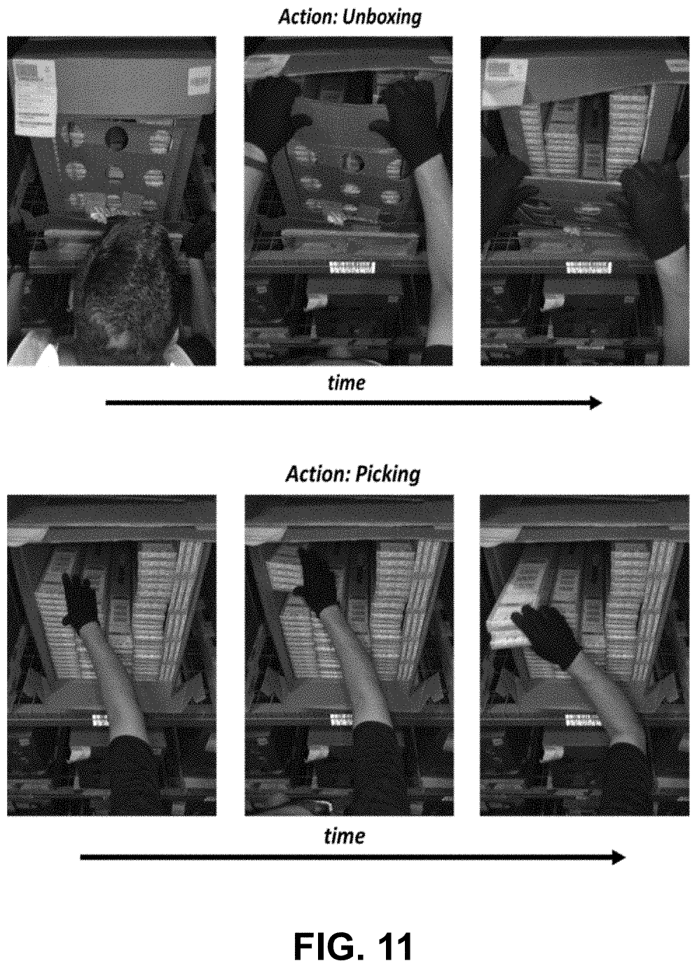

The cameras are mounted on the vehicle at multiple locations to capture the activities from different viewpoints. If the items are occluded in one of the viewpoints, one can use images from other cameras to fill in the information. This helps mitigate the issue of potential occlusion as no constraint is placed on user behavior. The recording is triggered when the vehicle stops at a certain location, or when a certain action is detected. The text, bar-code information at the location as well as on the box to triangulate our position in the warehouse is captured. The video recording stops when the vehicle starts moving again. The video recording involves all the activities which operator performs on the location to pick or place items. Some example actions are shown in FIG. 11. FIG. 11 shows example frames of key actions—unboxing and picking.

### Workflow

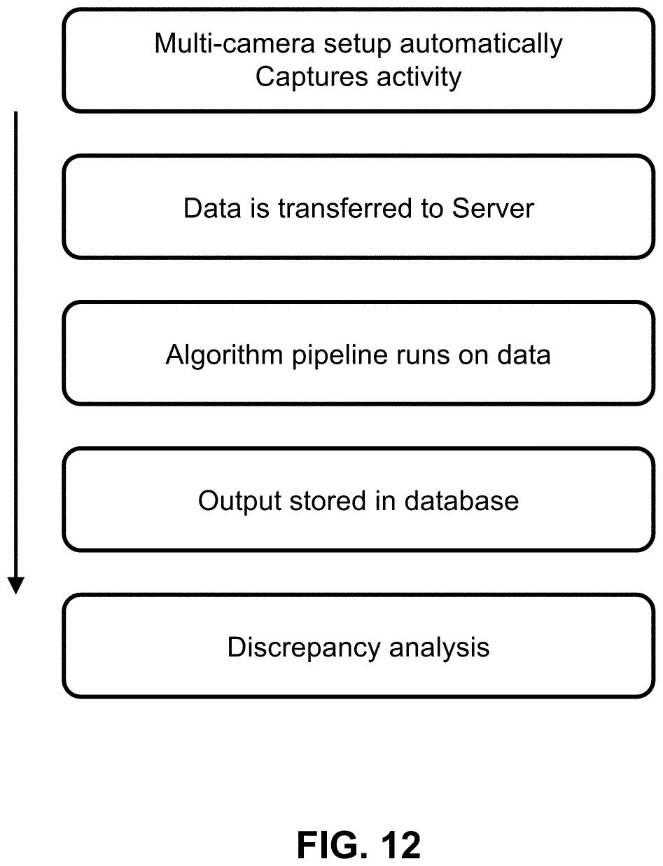

FIG. 12 shows a workflow of the overall pipeline from data capture to output dump.

### Algorithm

### Summary

Coarse action recognition
Item counting:
   Object tracking
   Fine action recognition
   Change detection
Consolidation
Discrepancy analysis

### Coarse Action Recognition

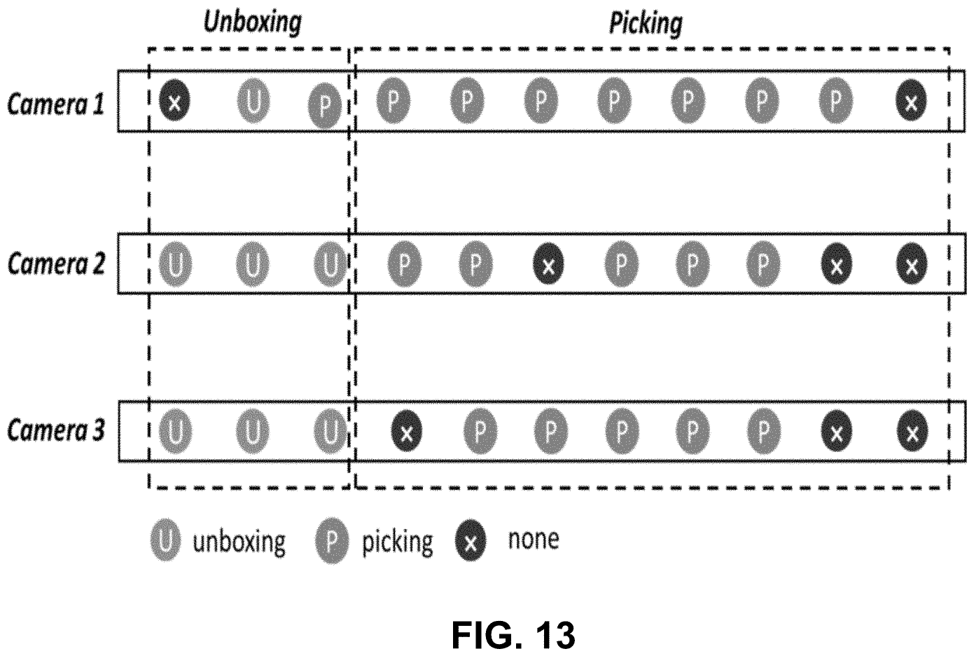

The first step is to identify the parts of video (video segments) where different activities such as unboxing, picking, placing are performed. These activities can take place at multiple times in a video. A pre-defined window of a small-time duration (of few frames) is taken and slid across the video to identify actions in each window. Activity Recognition network can be used to perform this task. This is done on frames from all cameras. For each camera, the window is slid across all frames and activity is identified corresponding to each frame (output of activity recognition on window centered around that frame). Then contiguous blocks of each activity are detected by taking statistical mode across cameras. FIG. 13 shows a diagrammatic explanation of action segmentation mechanism. Each frame has an action associated with it. Crosses represent that no action could be identified with reasonable confidence. Since networks are bound to have few false detections, taking a statistical mode across cameras helps mitigate that limitation.

### Item Counting

Once the timestamps of each picking and placing activity are determined, segmented videos are taken to analyze number of items involved in the activity. This done by multiple approaches—object tracking, fine action recognition and change detection. Each of these approaches are explained below:

### Object Tracking

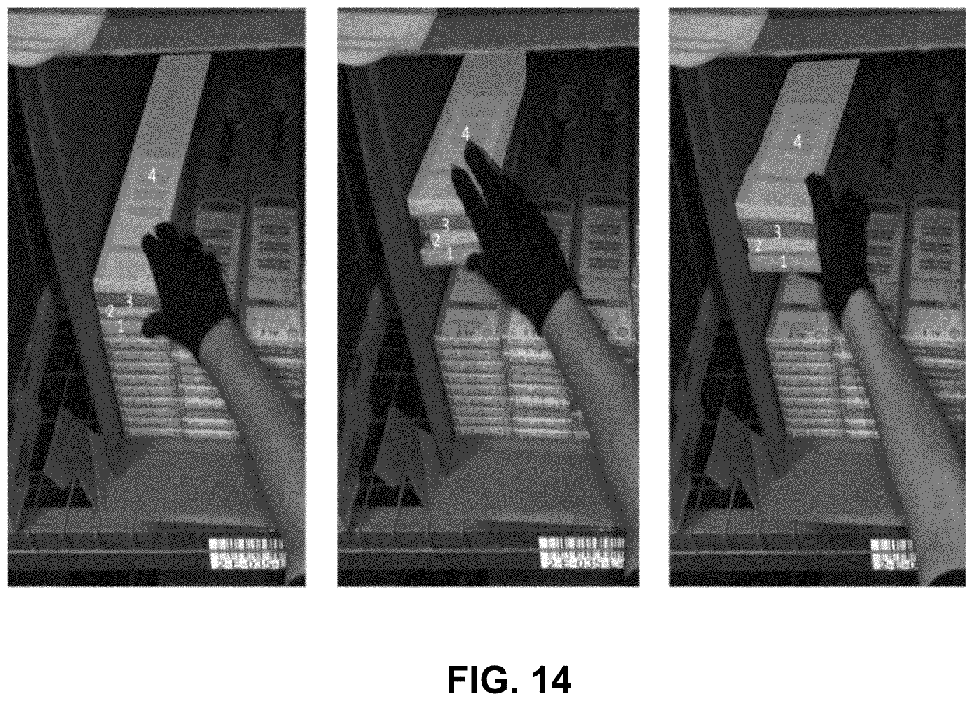

Train and deploy segmentation plus tracking neural networks to do the item counting as they move along the frames. Segmentation over detection is preferred as one would be dealing with cases of severe occlusion such as split objects. Each object in the frame is assigned an identifier (id) and is used to track that across frames. Even if the object is occluded for few frames and appears again, the associations are identified. Each object is tracked during the segment duration. An object that leaves the scene is counted as picked object. Objects added/returned to the scene is counted as returned item. All picked and placed items are summarized for each activity segment. FIG. 14 shows segmentation and tracking results shown on a video segment. Object correspondence across frame is shown through color as well as ID. Only the picked items are highlighted to make the visualization better.

### Fine Action Recognition

An additional Activity Recognition is trained to identify the actions with the number of items it is applied to. Those actions would be—“x items are picked” and “x items added” where x [0, n]. A stream of stacked videos from all cameras is used to identify an action with number of items as well. The idea behind using multiple cameras for fine action recognition is to use data from different viewpoints as it can help in cases of occlusion.

### Change Detection

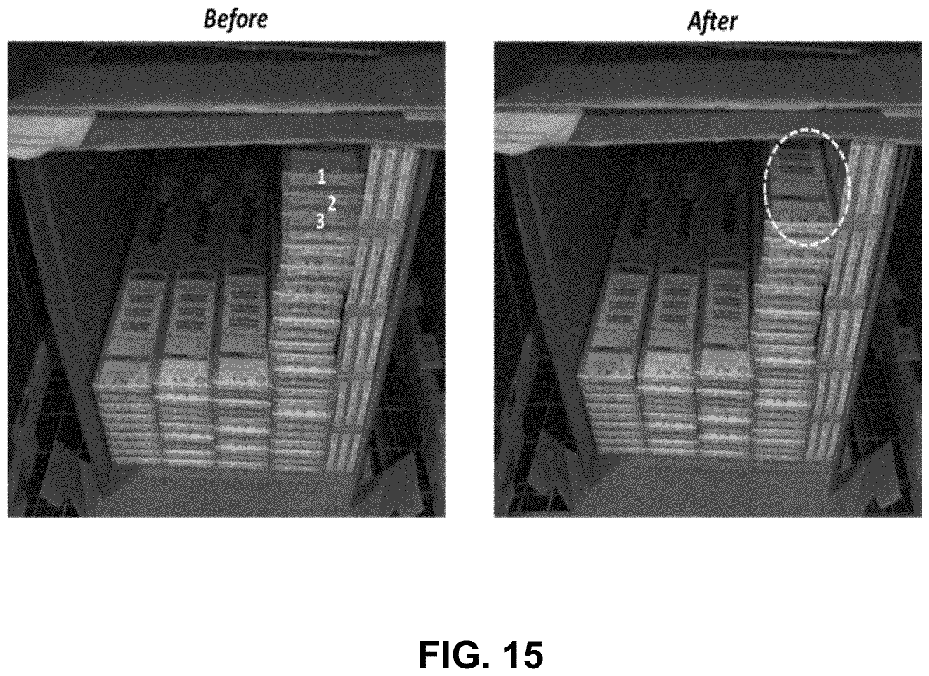

This approach is applicable for the cases where the front face of the box is opened for performing the activities. The start and end frames of the video segment are taken. Instance segmentation is applied on these frames. A comparison is then performed to identify the change (missing, added) in the box contents. FIG. 15: Before and after snapshots of the opened box. instance segmentation network is applied on both images to identify missing or extra items. In the example, one can find that 3 items are missing in the “after” image. Only the delta items are highlighted to make the visualization better.

The item count from each of these approaches is computed along with confidence scores. An intelligent confidence-based voting system is used to then compute the final number of objects.

### Consolidation

Analysis on each segment of the whole video gives us number of objects picked or placed. Finally, the count from each segment is taken to get the total number of items exchanged in the complete transaction. Final number of items remaining in the box is computed by the equation below:

Itemsfinal−Itemsinitial−ΣNpicked+Nplaced

### Discrepancy Analysis

The algorithm output is compared with the warehouse database. The aim is to identify any discrepancy and report to the inventory clerk. The discrepancies covered under the analysis will be to identify incorrect number of items picked or placed. Once discrepancies are identified, the clerk can be notified with links to corresponding videos for manual verification.

### Customer Analytics Use Cases

Identify discrepancies
   Item counting
Workforce analytics
   Efficiency analysis
   Behavior analysis
Safety guidelines violation detection

### QC Station Pipeline

### Objective

Verify the pick-list generated from WMS with visual imagery of the tote placed on a platform. The tote can be captured from multiple cameras to cover the full view. The aim is to identify and subsequently verify the items against the pre-generated pick-list to generate any potential discrepancies.

### Setup

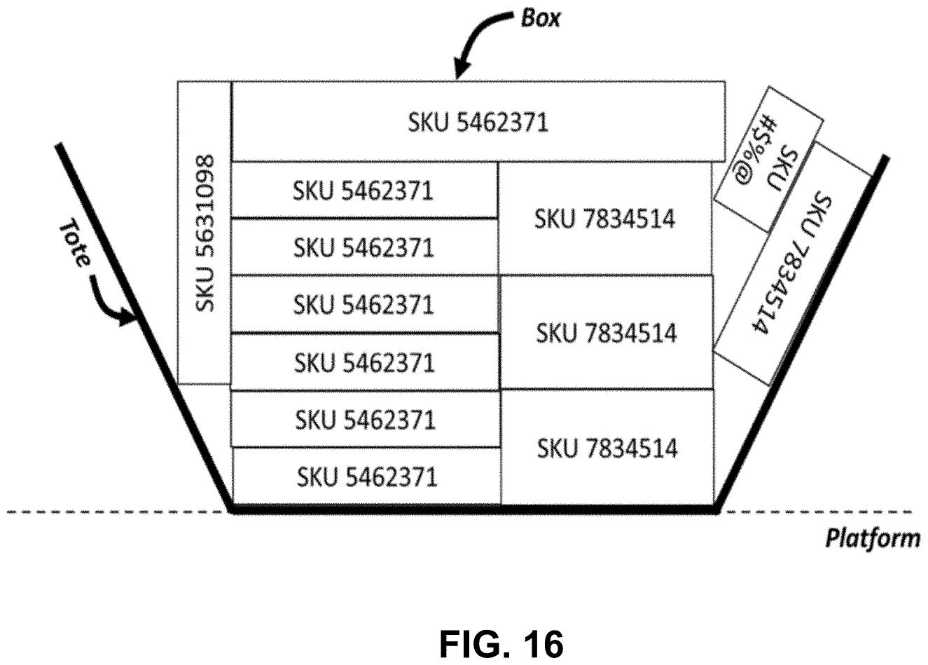

The setup on the platform is demonstrated in a pictorial way in FIG. 16.

### Capture Mechanism

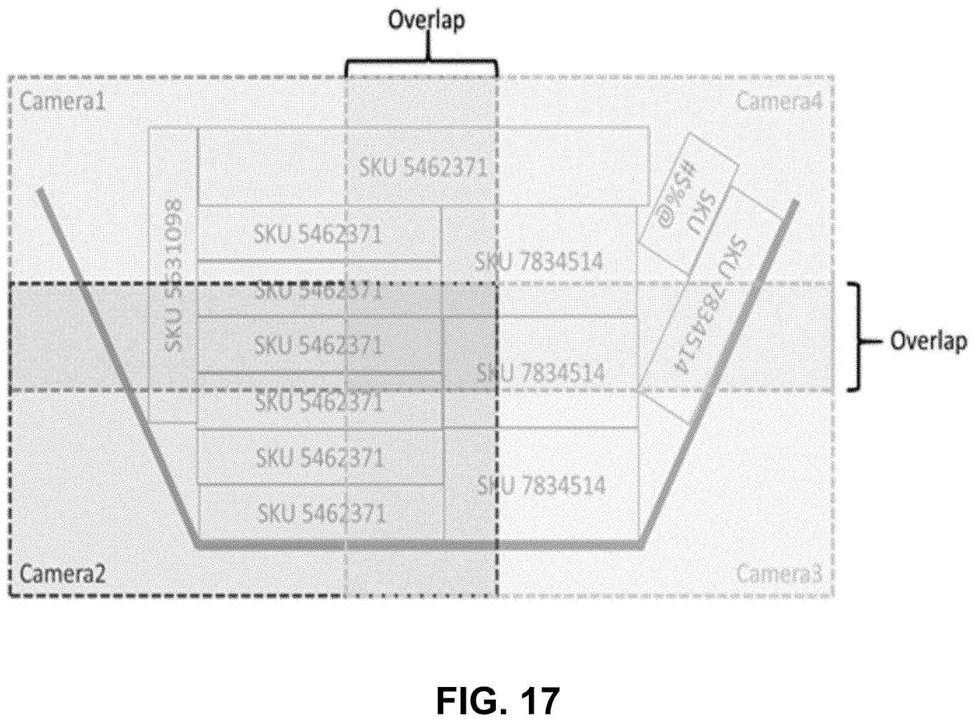

The fonts on boxes are small in physical dimensions and the camera is limited in terms of field-of-view and resolution per inch. This leads one to have a multi-camera setup capturing the tote. The cameras are arranged in a grid fashion with each camera having an overlapping field-of-view with its neighbor. This helps one register (stitch) the captures from all cameras on a single canvas to get a consolidated output. In addition, in the event there are multiple QC Stations in the warehouse, it may be necessary to identify the location and identity of each specific QC Station in the warehouse. For this purpose, the embedded sensor module can also contain other sensors and cameras to detect the specific location of this QC station in the warehouse. The setup is explained below in a graphical format in FIG. 17.

### Workflow

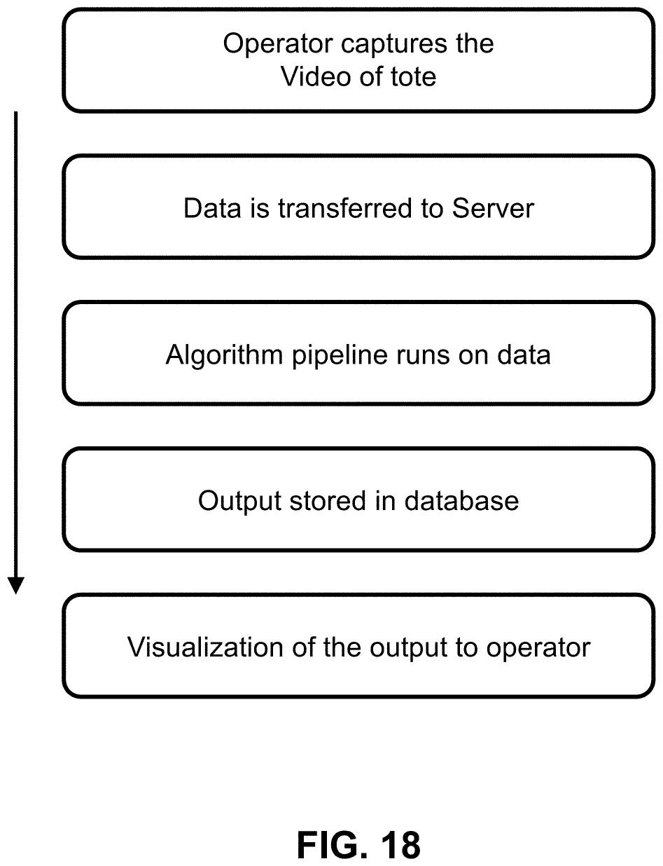

FIG. 18 shows the workflow of the overall pipeline from data capture to output dump for the QC station.

### Algorithm

### Summary

Inference
   Box and text detection
   Text recognition
   Association of text and boxes
Stitching
Consolidation
Discrepancy analysis

### Inference

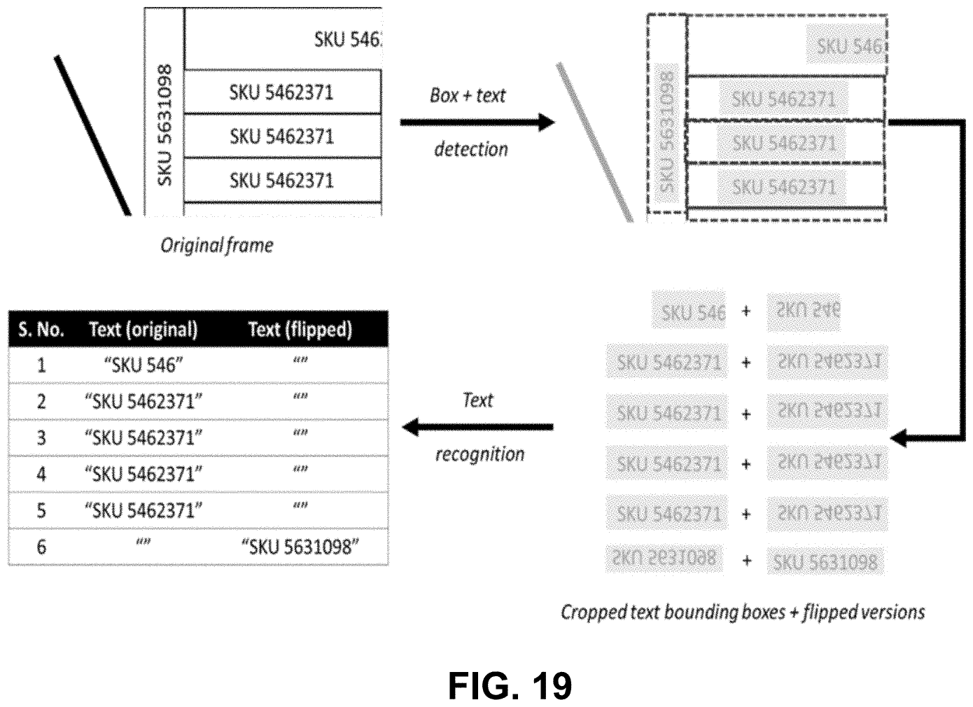

A machine learning network is applied to detect boxes and text regions. The output is given in a format of center coordinates, dimensions and angle from horizontal. The bounding boxes of text-regions are then used to crop the original image which is given as an input to a text recognizer network. The cropped images are flipped vertically also to cover cases where boxes are placed upside down. Even partial boxes and text regions are detected. Once text is recognized, we associate boxes and text by checking overlap. This inference process is shown in FIG. 19.

### Stitching

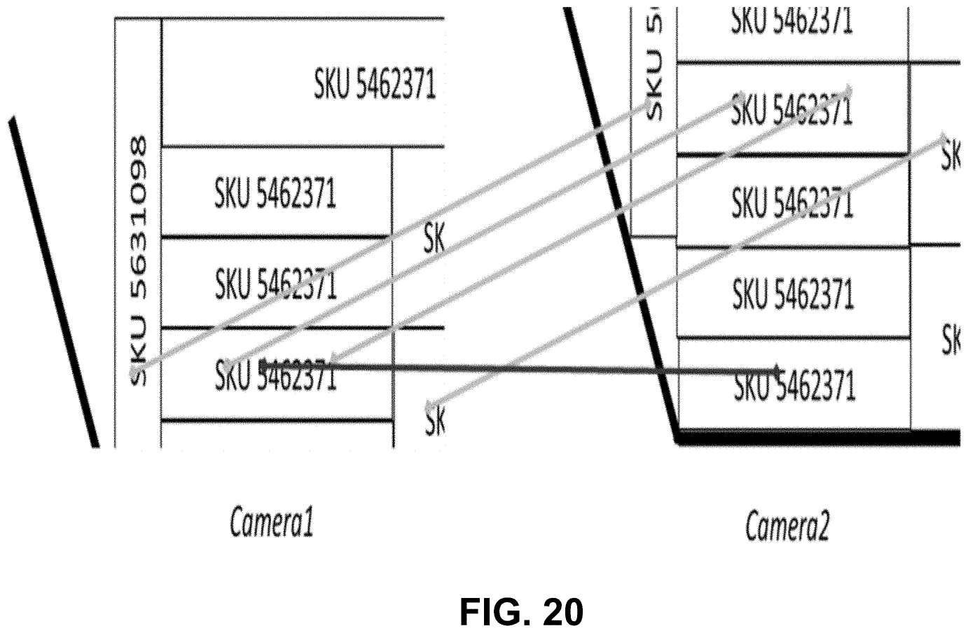

The frames are stitched in anti-clockwise order. To perform stitching, pair-wise images are taken and extract features. Known positional information of cameras is used to get overlap direction to give a more accurate mask for feature detection. For example, when frames from Camera 1 and Camera 2 are stitched, features are extracted from bottom-half of Camera1 and top half of Camera2. This helps one avoid getting features from non-overlapping region. After feature extraction, the features are matched to get correspondences. Feature matching is evaluated through metrics to filter out weak matches. Strong matches are then carried forward to compute homography matrix transformation between the images. The same transformation derived from images is then applied to box and text coordinates as well. This stitching process is shown in FIG. 20.

### Consolidation

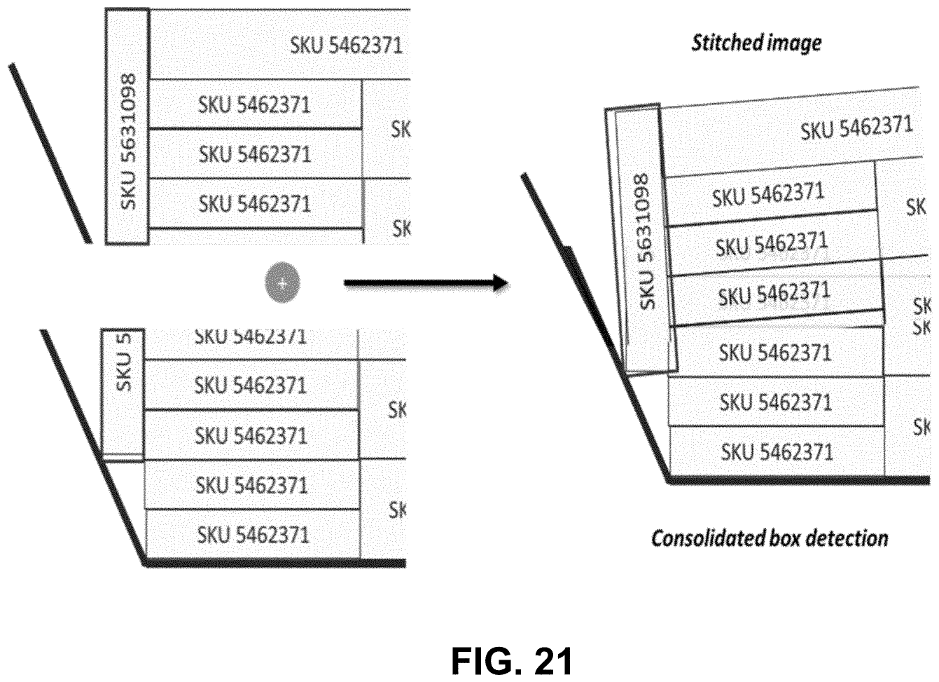

All the individual frames are brought to same stitched canvas. Same transformations are also applied to the box and text detections. Some boxes are captured partially in each frame. Transformed boxes are merged based on overlap metric called intersection over union (IoU). After merging all the boxes, consolidated output is evaluated to find boxes and their corresponding tags. The consolidation process is depicted in FIG. 21.

### Discrepancy analysis

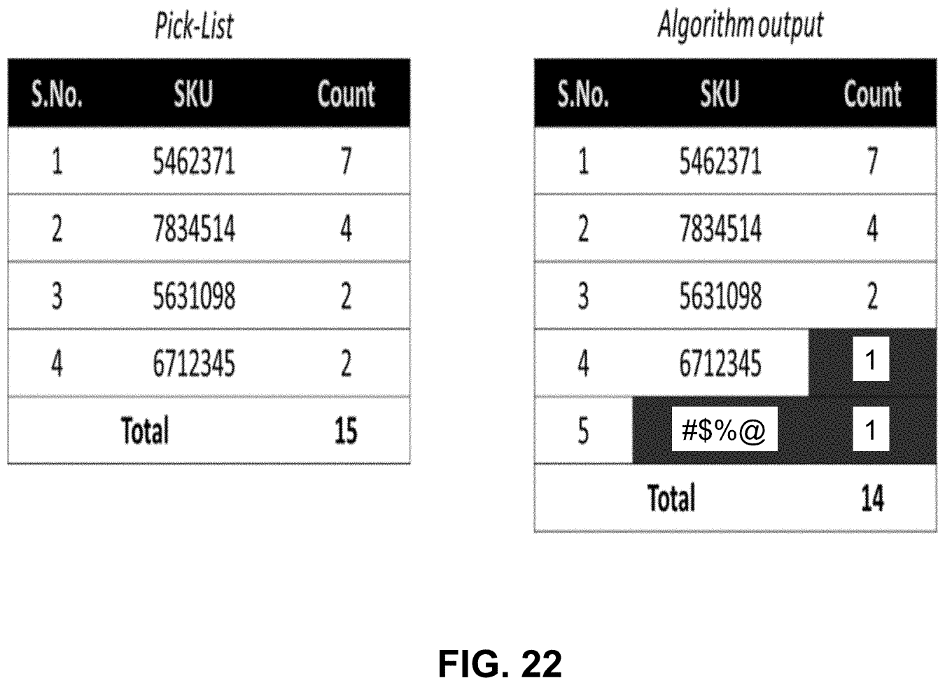

The algorithm output is compared with generated pick-list. The aim is to identify any discrepancy and report to the operator. The discrepancies covered under the analysis will be to identify missing boxes, incorrect boxes and stray boxes. Once discrepancies are identified, one can notify the operator with links to original image for manual verification. The discrepancy analysis is illustrated in FIG. 22.

### Customer Analytics Use Cases

Identify discrepancies from pick-list
   Boxes with incorrect tag
   Boxes with no tag
   Missing boxes with specific tag
Damage detection

What is claimed is:

1. A method of tracking and digitization for warehouse inventory management, comprising:
(a) having a warehouse with inventory locations for storing inventory, wherein the warehouse has unique markers throughout the warehouse for tracking location, and wherein the inventory has unique inventory information features for identifying inventory;
(b) having a vehicle capable of transporting the inventory, wherein the vehicle is operated by a human operator who moves the vehicle throughout the warehouse and who manipulates the inventory, wherein the vehicle has mounted thereon a plurality of cameras;
(c) capturing images of the unique markers by at least one of the plurality of cameras mounted on the vehicle;
(d) determining vehicle location information of the vehicle while the vehicle is moving throughout the warehouse by processing the captured images of the unique markers captured by at least one of the plurality of cameras mounted on the vehicle;
(e) capturing images of the inventory with at least one of the plurality of cameras on the vehicle during the manipulation;
(f) digitizing at least one of the captured images and extracting the unique inventory information features from the captured images of the inventory during the manipulation, wherein the unique inventory information features uniquely identify the inventory;
(g) determining a unique inventory location of the inventory at the moment of the manipulation by synchronizing the extracted unique inventory information features and the determined vehicle location information of the vehicle; and
(h) maintaining a warehouse inventory management system with the determined inventory location during the manipulation.

2. The method as set forth in claim 1, wherein the plurality of cameras are selected from the group consisting of one or more forward-facing cameras with respect to the vehicle, one or more top-down-facing cameras with respect to the vehicle, one or more diagonal-downward-facing cameras with respect to the vehicle, one or more upward facing cameras, one or more back facing cameras, one or more side facing cameras.

3. The method as set forth in claim 1, wherein the method consisting essentially of using cameras for the determining a unique inventory location of the inventory.

4. The method as set forth in claim 1, wherein the vehicle further comprises position and inertial sensors to capture position and movement information of the vehicle and the inventory, wherein the position and movement information assists in the determining of the unique inventory location of the inventory.

5. The method as set forth in claim 1, wherein the determining vehicle location information of the vehicle does not have RFID tags or bar codes throughout the warehouse and the determining vehicle location information of the vehicle does not use RFID sensors for reading the RFID tags or bar code readers for reading the bar codes.

6. The method as set forth in claim 1, wherein the unique markers throughout the warehouse for tracking location are warehouse markers on a wall, on a floor, on a bin, on a rack, placed overhead over the inventory locations, identifying an aisle, on light fixtures, or on pillars.

7. The method as set forth in claim 1, wherein the unique inventory information features are manufacturer logos, Stock Keeping Unit (SKU) numbers, Barcodes, Identification Numbers, Part numbers, box colors, or pallet colors.

8. The method as set forth in claim 1, wherein the method utilizes more than one vehicle.

9. The method as set forth in claim 1, wherein the determining vehicle location information of the vehicle only starts when the vehicle is moving.

10. The method as set forth in claim 1, wherein the capturing images of the inventory only starts when the human operator is about to manipulate the inventory.

11. The method as set forth in claim 1, wherein the manipulation is selected from the group consisting of one or more of the steps of moving the inventory with the vehicle from an entry of the inventory into the warehouse to a departure of the inventory out of the warehouse, storing the inventory by the at least one vehicle at the inventory locations, and picking up the inventory with the at least one vehicle from the inventory locations.

12. The method as set forth in claim 1, further comprising updating the inventory in the warehouse management system when the inventory is picked from the unique inventory location or put away to the unique inventory location.

13. The method as set forth in claim 1, further comprising verifying a correct number of inventory items has been picked from the unique inventory location or put away to the unique inventory location.

14. The method as set forth in claim 1, further comprising building a digital map of the unique inventory locations of the inventory in the warehouse.

15. The method as set forth in claim 1, further comprising using software to obscure faces to maintain privacy.

16. The method as set forth in claim 1, further comprising using face recognition software to recognize faces for security in the warehouse.

17. The method as set forth in claim 1, further comprising using face recognition software to ensure that only certified vehicle operators are operating the vehicles.

18. The method as set forth in claim 1, further comprising utilizing vehicle location information throughout a day or time window to improve productivity and efficiency.
